(19) United States
(12) Patent Application Publication
(10) Pub. No.: US 2009/0014331 A1
(43) Pub. Date: Jan. 15, 2009

(54) AMMONIA GAS SENSOR

(75) Inventors: Satoshi SUGAYA, Aichi (JP); Hiroyuki Nishiyama, Aichi (JP); Wataru Matsutani, Aichi (JP); Shiro Kakimoto, Aichi (JP); Hitoshi Yokoi, Aichi (JP)

Correspondence Address: SUGHRUE MION, PLLC, 2100 PENNSYLVANIA AVENUE, N.W., SUITE 800, WASHINGTON, DC, 20037, US

(73) Assignee: NGK SPARK PLUG CO., LTD., Nagoya (JP)

(21) Appl. No.: 12/170,707

(22) Filed: Jul. 10, 2008

(30) Foreign Application Priority Data
Jul. 11, 2007 (JP) 2007-181607
Oct. 17, 2007 (JP) 2007-269722
May 7, 2008 (JP) 2008-120859

(51) Int. Cl. G01N 27/26

(52) U.S. Cl. 204/427

(57) ABSTRACT

An ammonia gas sensor which includes a solid electrolyte member (310) extending in an axial direction; a reference electrode (320) provided on the solid electrolyte member (310); and a detection electrode (331) and a selective reaction layer (340) provided on the solid electrolyte member (310). The detection electrode serves as a counterpart of the reference electrode (320). The detection electrode (331) contains a noble metal as a predominant component, and the selective reaction layer (340) contains a metal oxide as a predominant component.

### BACKGROUND OF THE INVENTION

1. Field of the Invention

The present invention relates to an ammonia gas sensor adapted for detecting ammonia gas contained in a gas under measurement.

2. Description of the Related Art

A representative, conventional ammonia gas sensor is disclosed in Patent Document 1. The ammonia gas sensor includes a solid electrolyte member, and reference and detection electrodes provided on the solid electrolyte member. The detection electrode is formed of a metal oxide having ammonia gas selectivity, such as vanadium oxide (V₂O₅).

[Patent Document 1] U.S. Published Patent Application No. 2006-0266659 A1

### PROBLEMS TO BE SOLVED BY THE INVENTION

A detection electrode formed of vanadium oxide (V₂O₅) exhibits insufficient responsiveness and selectivity for ammonia gas.

### SUMMARY OF THE INVENTION

In view of the foregoing drawback, an object of the present invention is to provide an ammonia gas sensor which exhibits excellent responsiveness and selectivity for ammonia gas in a gas under measurement.

The above objects have been achieved in a first (1) aspect of the invention by providing an ammonia gas sensor comprising a solid electrolyte member extending in an axial direction and containing zirconia as a predominant component; a reference electrode provided on the solid electrolyte member; and a detection electrode and a selective reaction layer provided on the solid electrolyte member, wherein the detection electrode serves as a counterpart of the reference electrode, wherein the detection electrode contains a noble metal as a predominant component, and the selective reaction layer contains a metal oxide as a predominant component.

By virtue of this configuration, the selective reaction layer effectively burns and removes combustible gasses in a gas under measurement other than ammonia gas, to thereby prevent combustible gasses from reaching the solid electrolyte member.

In addition, the detection electrode exhibits a current-collecting action upon exposure to ammonia gas. Therefore, an electromotive force can be effectively generated between the detection electrode and the reference electrode in accordance with the concentration of ammonia gas.

As a result, an ammonia gas sensor can be obtained which is not influenced by combustible gasses and which has excellent responsiveness and selectivity for ammonia gas.

In the present invention, the selective reaction layer and the detection electrode are provided as two separate layers. If the selective reaction layer and the detection electrode are formed as a single layer (a layer in which the noble metal contained in the detection electrode and the metal oxide contained in the selective reaction layer are present in a mixed state), the current-collecting action of the detection electrode is lowered. This makes generation of a suitable electromotive force (i.e., an electromotive force suitable for detecting ammonia gas in the gas under measurement) between the detection electrode and the reference electrode layer difficult, and combustible gasses other than ammonia gas can reach the interface between the detection electrode and the solid electrolyte member. Therefore, an ammonia gas sensor having excellent gas selectivity and responsiveness cannot be obtained. In contrast, when the above-described configuration of the present invention is employed, an ammonia gas sensor having excellent gas selectivity and responsiveness can be obtained.

Notably, no particular limitation is imposed on the arrangement of the detection electrode and the selective reaction layer insofar as the detection electrode and the selective reaction layer are formed on the surface of the solid electrolyte member to serve as a counterpart of the reference electrode. For example, the detection electrode and the selective reaction layer may face the reference electrode via the solid electrolyte member, or may be disposed on the same surface of the solid electrolyte member together with the reference electrode. Further, the detection electrode, the selective reaction layer and the solid electrolyte member may be in direct contact with one another, or another member may be interposed therebetween.

In a preferred embodiment (2), as applied to (1) above, the detection electrode is arranged between the solid electrolyte member and the selective reaction layer. By virtue of this configuration, a gas under measurement first comes into contact with the selective reaction layer, so that ammonia gas in the gas under measurement reaches the solid electrolyte member after combustible gasses in the gas under measurement other than ammonia gas have been sufficiently burnt.

In yet another preferred embodiment (3), as applied to (2) above, the detection electrode is disposed directly on the solid electrolyte member. This configuration allows the detection electrode to exhibit good current-collecting action upon exposure to ammonia gas. As a result, an electromotive force can be generated more effectively between the detection electrode and the reference electrode in accordance with the concentration of ammonia gas.

In yet another preferred embodiment (4), as applied to (1) to (3) above, the selective reaction layer covers the detection electrode such that the detection electrode is not exposed. Since the detection electrode portion is completely covered by the selective reaction layer, the gas under measurement passes through the selective reaction layer, without fail, before reaching the solid electrolyte member. In this case, ammonia gas in the gas under measurement reaches the solid electrolyte member after combustible gasses in the gas under measurement other than ammonia gas have been burned almost completely at the selective reaction layer.

In yet another preferred embodiment (5), as applied to (4) above, a strip-shaped detection lead portion is provided which extends in the axial direction from the detection electrode so as to electrically connect the detection electrode to an external circuit, and the detection electrode overlaps the detection lead. This configuration allows the detection electrode and the detection lead to be electrically connected in a reliable manner, whereby an electromotive force generated between the reference electrode and the detection electrode can be reliably transmitted to an external circuit.

In yet another preferred embodiment (6), as applied to (1) above, the solid electrolyte member assumes the form of a bottomed tube having a bottom portion at a front end side thereof; the reference electrode is formed on an inner surface of the solid electrolyte member; and the detection electrode is provided on an outer surface of a front end portion of the solid electrolyte member. Even in an ammonia gas sensor in which the solid electrolyte member assumes the form of a bottomed tube, and the reference electrode and the detection electrode are provided on the inner surface and the outer surface, respectively, of the solid electrolyte member, by providing a detection electrode containing a noble metal as a predominant component and the selective reaction layer containing a metal oxide as a predominant component, excellent responsiveness and selectivity for ammonia gas can be attained.

In yet another preferred embodiment (7), as applied to (6) above, the detection electrode may be formed such that the detection electrode assumes a strip-like shape and extends symmetrically toward the rear end side of the solid electrolyte member while passing along the bottom portion of the solid electrolyte member.

In yet another preferred embodiment (8), as applied to (4) to (7) above, the detection electrode is formed of a material which contains platinum as a predominant component and gold, or a material which contains gold as a predominant component. This configuration allows the detection electrode to exhibit good current-collecting action upon exposure to ammonia gas. As a result, an electromotive force can be generated more effectively between the detection electrode and the reference electrode in accordance with the concentration of the ammonia gas.

In yet another preferred embodiment (9), as applied to (4) to (8) above, the detection lead is formed of a material which contains platinum as a predominant component. By virtue of this configuration, the electromotive force generated between the detection electrode and the reference electrode can be reliably transmitted to an external circuit.

In yet another preferred embodiment (10), as applied to (9) above, the gold content (wt %) of the detection lead is less than the gold content (wt %) of the detection electrode. The gold contained in the detection lead lowers the catalytic activity of platinum, and suppresses generation of a potential difference between the detection lead and the reference electrode. In addition, since the gold content of the detection lead is less than the gold content of the detection electrode, the detection lead can be fired simultaneously with the solid electrolyte member, and adhesion to the solid electrolyte member can be increased. Moreover, adhesion to the detection electrode can also be increased.

In yet another preferred embodiment (11), as applied to (4) to (10) above, the reference electrode and the detection electrode each contains zirconia, and the zirconia content (wt %) of the detection electrode is less than the zirconia content (wt %) of the reference electrode. Zirconia is incorporated into the reference electrode and the detection electrode in consideration of adhesion to the solid electrolyte member. By rendering the zirconia content of the detection electrode less than the zirconia content of the reference electrode, good current-collecting action of the detection electrode based on ammonia gas is maintained.

In yet another preferred embodiment (12), as applied to (4) to (11) above, the detection lead contains zirconia, and the zirconia content (wt %) of the detection lead is less than the zirconia content (wt %) of the detection electrode. As described above, zirconia is incorporated into the detection lead as well, in consideration of adhesion to the solid electrolyte member. By rendering the zirconia content of the detection lead less than the zirconia content of the detection electrode, the electrical conductivity of detection lead can be enhanced.

In yet another preferred embodiment (13), as applied to (2) above, a porous layer is provided between the detection electrode and the selective reaction layer. This configuration insulates the selective reaction layer from the detection electrode. Accordingly, the influence of age-related deterioration of the selective reaction layer on the detection electrode can be prevented, and good gas selectivity can be maintained over a long period of time.

In yet another preferred embodiment (14), as applied to (13) above, the porous layer covers the detection electrode such that the detection electrode portion is not exposed. By virtue of this configuration, the porous layer reliably insulates the detection electrode from the selective reaction layer.

In yet another preferred embodiment (15), as applied to (13) above, the selective reaction layer covers the porous layer such that the porous layer is not exposed. This configuration prevents combustible gasses other than ammonia gas from flowing directly to the detection electrode via the porous layer, without passing through the selective reaction layer. Thus, a sensor having excellent selectivity for ammonia gas can be obtained.

In yet another preferred embodiment (16), as applied to (3) above, the porous layer contains at least one selected from the group consisting of Al₂O₃, MgAl₂O₄, SiO₂, SiO₂/Al₂O₃, porous aluminosilicate and SiC. In this manner, the insulation properties of the porous layer can be secured more concretely. The porous aluminosilicate includes zeolites such as ZSM-5 well known as an industrial zeolite having a high silica and a low aluminum content. ZSM-5 has a structure including first pores having a straight and elliptical cross section and second pores intersecting the straight pores at right angles in a zig-zag pattern and having a circular cross section.

In yet another preferred embodiment (17), as applied to (2) above, a protection layer is provided to cover the selective reaction layer such that the selective reaction layer is not exposed. By virtue of this configuration, the selective reaction layer is not affected by impurities (for example, phosphorous, lead, etc.) present in the gas under measurement. Therefore, the selective reaction layer can satisfactorily burn combustible gasses in the gas under measurement other than ammonia gas to thereby prevent combustible gases from reaching the solid electrolyte member. The protection layer may be made of MgAl₂O₄, Al₂O₃, SiO₂/Al₂O₃, porous aluminosilicate, or the like.

In yet another preferred embodiment (18), as applied to (1) above, the selective reaction layer contains, as a predominant component, at least one of bismuth vanadium oxide and antimony vanadium oxide. By virtue of this configuration, the selective reaction layer can satisfactorily burn combustible gasses in the gas under measurement other than ammonia gas.

In yet another preferred embodiment (19), as applied to (18) above, the selective reaction layer further contains, as an additional component, at least one oxide selected from the group consisting of tungsten oxide, molybdenum oxide, niobium oxide, tantalum oxide, magnesium oxide, calcium oxide, strontium oxide and barium oxide. When such an additional component is added to the selective reaction layer, the selective reaction layer can more effectively burn combustible gasses in the gas under measurement other than ammonia gas.

In yet another preferred embodiment (20), as applied to (18) above, the selective reaction layer contains vanadium in an amount of 25 at % to 50 at % (atom %) based on total content of vanadium, antimony and bismuth in the selective reaction layer. In this manner, the gas sensor can secure satisfactory thermal stability over time, good responsiveness, and good selectivity for ammonia gas.

In yet another preferred embodiment (21), as applied to (1) above, the selective reaction layer is thicker than the detection electrode. This configuration allows the selective reaction layer to effectively separate ammonia gas from combustible gasses other than ammonia gas, to thereby prevent combustible gasses other than ammonia gas from reaching the solid electrolyte member.

In yet another preferred embodiment (22), as applied to (1) above, the detection electrode has a thickness of less than 30 μm. This configuration allows the detection electrode to exhibit satisfactory thermal shock resistance and satisfactory current-collecting characteristics, and to secure satisfactory responsiveness for ammonia gas.

### BRIEF DESCRIPTION OF THE DRAWINGS

FIG. 1 is a cross sectional view of the ammonia gas sensor 1 of Embodiment 1 of the present invention.

FIG. 2 is an enlarged cross sectional view of a front end portion of the sensor element 300 of Embodiment 1.

FIG. 3 is an enlarged side elevational view of the front end portion of the sensor element 300 of Embodiment 1.

FIG. 4 is an enlarged cross sectional view of a front end portion of the sensor element 400 of Embodiment 2.

FIG. 5 is an enlarged side elevational view of the front end portion of the sensor element 400 of Embodiment 2.

FIG. 6 is an enlarged cross sectional view of a front end portion of the sensor element 500 of Embodiment 3.

FIG. 7 is a perspective view of the sensor element 900 of Embodiment 4.

FIG. 8 is a cross sectional view of the sensor element 900 of Embodiment 4.

FIG. 9 is an exploded perspective view of the sensor element 900 of Embodiment 4.

FIG. 10 is an evaluation graph of Test Example 1.

FIG. 11 is an evaluation graph of Test Example 2.

FIG. 12 is an evaluation graph of Test Example 3.

FIG. 13 is an evaluation graph of Test Example 4.

FIG. 14 is an evaluation graph of Test Example 5.

FIG. 15 is an evaluation graph of Test Example 6.

### DESCRIPTION OF REFERENCE NUMERALS

Reference numerals used to identify various structural features in the drawings include the following.

310: solid electrolyte layer

320: reference electrode

331, 371: detection electrode

350: heater

332, 372: detection lead

330: porous layer

340: selective reaction layer

360: protection layer

### DETAILED DESCRIPTION OF THE PREFERRED EMBODIMENTS

The ammonia gas sensor according to the invention will now be described in greater detail with reference to the drawings. However, the present invention should not be construed as being limited thereto.

As used herein, “predominant” means in an amount greater than 50 wt %.

### Embodiment 1

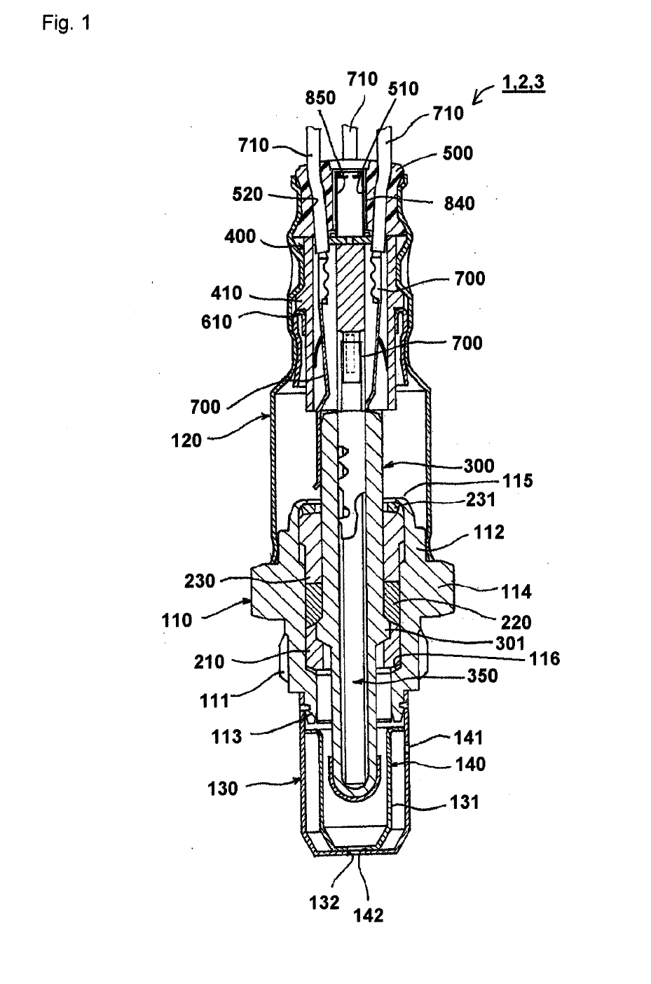

FIG. 1 is a sectional view of an ammonia gas sensor 1 of Embodiment 1. In use, the ammonia gas sensor 1 is attached to, for example, an exhaust pipe (not shown) of an internal combustion engine of an automobile or the like. Notably, in the following description of Embodiment 1, the lower side and upper side of FIG. 1 will be referred to as the front end side and the rear end side, respectively.

The ammonia gas sensor 1 shown in FIG. 1 is configured such that a tubular sensor element 300 closed on its front end side is held in a metallic shell 110. Further, lead wires 710 extend from the ammonia gas sensor 1 so as to extract an output signal of the sensor element 300 and supply electricity to a heater 350 provided adjacent to the sensor element 300. The lead wires 710 are electrically connected to an unillustrated sensor control apparatus or electronic control unit (ECU) of the automobile.

The metallic shell 110 is a tubular member formed of stainless steel such as SUS430, and includes, on its front end side, an external thread portion 111 which is mounted to an exhaust pipe (not shown). Further, a front end engagement portion 113, with which an outer protector 130 described below is engaged, is provided on the front end side of the external thread portion 111.

Meanwhile, on the rear end side of the external thread portion 111 of the metallic shell 110, a tool engagement portion 114 is provided, with which an attachment tool is engaged so as to attach the ammonia gas sensor 1 to the exhaust pipe. Further, a crimp portion 115 is provided at the rear end of the metallic shell 110 so as to fixedly crimp the sensor element 300. A rear end engagement portion 112, with which an outer tube 120 described below is engaged, is provided between the tool engagement portion 114 and the crimp portion 115.

A step portion 116 which projects radially inward is provided inside the metallic shell 110. A tubular support member 210 made of alumina is supported on the step portion 116 via a packing made of metal (not shown). The inner circumference of the support member 210 is also shaped to have a step, which supports a flange portion 301 of the sensor element 300 described below, via a packing made of metal (not shown). Further, on the rear end side of the support member 210, a charging material 220 made of talc powder is charged, and a sleeve 230 made of alumina is disposed, so that the charging material 220 is held between the sleeve 230 and the support member 210.

An annular ring 231 is disposed on the rear end side of the sleeve 230. By crimping the crimp portion 115 of the metallic shell 110, sleeve 230 is pressed against the charging material 220 via the ring 231.

The outer protector 130, which covers a front end portion of the sensor element 300, is attached to the front end engagement portion 113 of the metallic shell 110 by welding. An inner protector 140 having the form of a bottomed tube is fixedly provided within the outer projector 130. Introduction openings 131 and 141 are formed in the outer protector 130 and the inner protector 140, respectively, so as to introduce a gas under measurement to the interior of the inner protector 140. Further, discharge openings 132 and 142 are formed in the bottom walls of the outer protector 130 and the inner protector 140, respectively, so as to discharge water droplets and the gas under measurement which have entered the interior of the inner protector 140.

Meanwhile, the tubular outer tube 120 formed of stainless steel such as SUS304 is fixed to the rear end engagement portion 112 of the metallic shell 110 by means of laser welding or the like. The outer tube 120 extends rearward, and surrounds a rear end portion of the sensor element 300 and a separator 400 described below, which is disposed on the rear side of the sensor element 300. Notably, a portion of the outer tube 120 is crimped for engaging and fixing a holding metal piece 610 which holds the separator 400.

The separator 400 holds four connection terminals 700 (FIG. 1 shows three of the connection terminals 700), which are electrically connected to a reference electrode 320 and a detection electrode 331 of the sensor element 300 and a heating resistor of the heater 350. The conductors of the four lead wires 710 are connected to the corresponding connection terminals 700 by crimping (FIG. I shows three of the lead wires 710). The lead wires 710 extend to the outside of the ammonia gas sensor 1 via a grommet 500, described below. The separator 400 has a flange portion 410, which projects radially outward from the outer circumferential surface of the separator 400. The holding metal piece 610 supports the flange portion 410.

Further, the grommet 500, which has a generally cylindrical columnar shape and is made of a fluoro rubber, is disposed to close the rear end opening of the outer tube 120. A communication hole 510 passes through a radially central portion of the grommet 500 so as to introduce the atmosphere into the interior of the outer tube 120. Moreover, on the radially outer side of the communication hole 510, four lead-wire insertion holes 520 are provided at equal intervals in the circumferential direction. The lead wires 710 are inserted into and passed through the lead-wire insertion holes 520.

A filter member 840 and a retaining metal piece 850 therefor are inserted into the communication hole 510 of the grommet 500. The filter member 840 is a membrane filter formed of a fluorocarbon resin such as PTFE (polytetrafluoroethylene) and which has a network structure. The filter member 840 prohibits passage of water droplets or the like therethrough, and allows passage of the atmosphere therethrough. The retaining metal piece 850 is a member formed into a tubular shape, holds the filter 840 between its outer circumference and the inner circumference of the communication hole 510, and is fixed to the grommet 500.

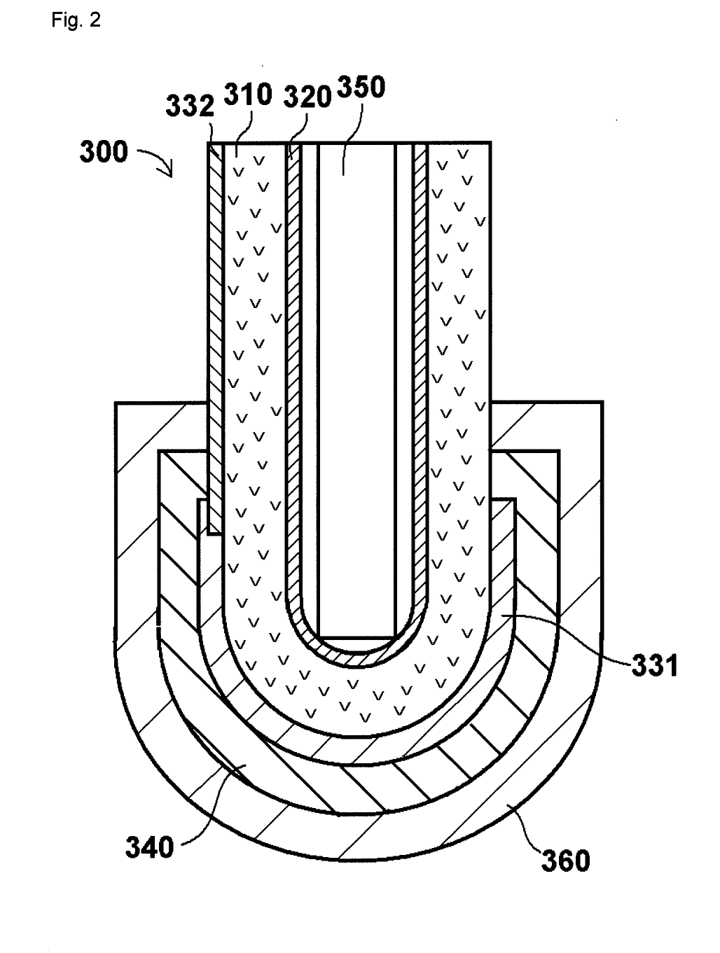

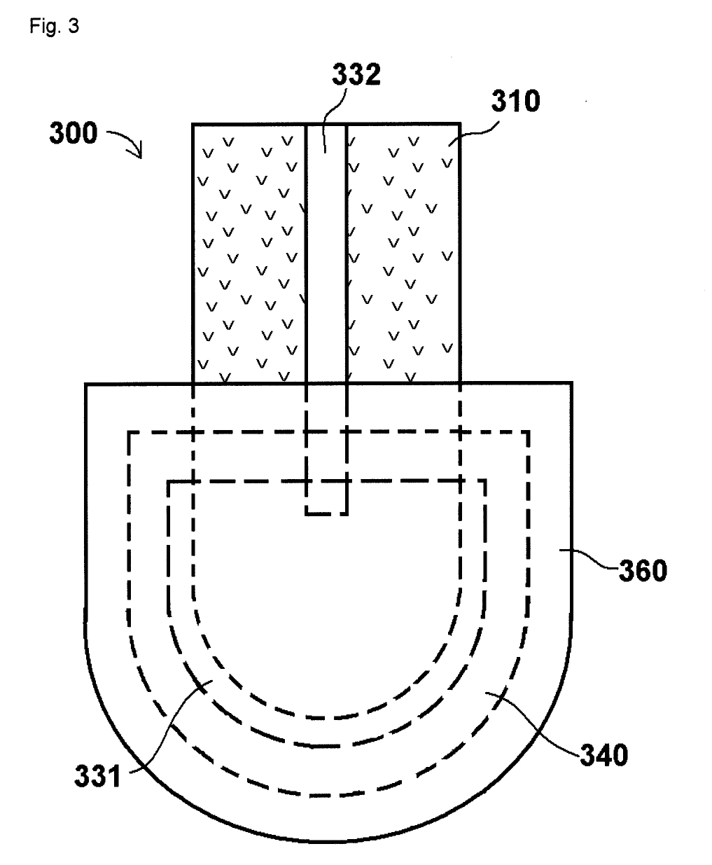

Next, the sensor element 300 will be described. FIG. 2 is an enlarged cross sectional view of a front end portion of the sensor element 300. FIG. 3 is an enlarged side elevational view of the front end portion of the sensor element 300. As shown in FIG. 1, the sensor element 300 includes a flange portion 301, which projects radially outward from a generally central portion of the sensor element 300. As shown in FIGS. 2 and 3, the sensor element 300 includes a solid electrolyte member 310 which contains zirconia as a predominant component and which has the form of a bottomed tube. The bar-shaped heater 350 is inserted into the solid electrolyte member 310 so as to heat and activate the solid electrolyte member 310.

The reference electrode 320, whose predominant component is Pt, is formed over the entire inner surface of the solid electrolyte member 310. Meanwhile, a detection electrode 331 and a selective reaction layer 340 are provided, in this order, directly on the outer surface of a front end portion of the solid electrolyte member 310. Further, a strip-shaped detection lead 332 is formed on the outer surface of the solid electrolyte member 310 such that it extends from the detection electrode 331. Notably, the detection electrode 331 extends onto (i.e., overlaps) the outer surface of a front end of the detection lead 332.

The detection electrode 331 has a thickness of 20 μm, and is formed of a material which contains Au (predominant component) and ZrO₂ (10 wt %). The detection lead 332 has a thickness of 15 μm, and is formed of a material which contains Pt (predominant component), ZrO₂ (5 wt %), and Au (5 wt %). Notably, ZrO₂ may be replaced with partially stabilized zirconia obtained by addition of yttria (Y) to ZrO₂.

The selective reaction layer 340 has a thickness of 30 μm, and is formed of a metal oxide which contains vanadium oxide (V₂O₅) and bismuth oxide (Bi₂O₃) as predominant components; e.g., bismuth vanadium oxide (BiVO₄). The mixing ratio between the vanadium oxide (V₂O₅) and bismuth oxide (Bi₂O₃) in this metal oxide is 45:55 (at %, V:Bi). The selective reaction layer 340 is formed over the entire outer surface of the detection electrode 331 such that the detection electrode 331 is not exposed to the outside (see FIGS. 2 and 3). Further, a protection layer 360 made of Al₂O₃ is formed on the surface of the selective reaction layer 340 such that the selective reaction layer 340 is not exposed.

In such an ammonia gas sensor 1, the selective reaction layer 340 satisfactorily burns and removes combustible gasses in a gas under measurement, and prevents the combustible gasses from reaching the solid electrolyte member 310. The detection electrode 331 exhibits a current-collecting action based on exposure to ammonia gas, so that an electromotive force is effectively generated between the reference electrode 320 and the detection electrode 331 in accordance with the concentration of ammonia gas. Therefore, the ammonia gas sensor 1 has excellent responsiveness and selectivity for ammonia gas. In particular, since the selective reaction layer 340 and the detection electrode 331 are provided as two separate layers, the gas selectivity and the responsiveness are further enhanced.

Since the detection electrode 331 is provided between the solid electrolyte member 310 and the selective reaction layer 340, the gas under measurement first comes into contact with the selective reaction layer 340, so that ammonia gas in the gas under measurement reaches the solid electrolyte member 310 after combustible gasses in the gas under measurement other than ammonia gas have been sufficiently burnt.

Since the detection electrode 331 is provided directly on the solid electrolyte member 310, the detection electrode 331 can exhibit further enhanced current-collecting action upon exposure to ammonia gas. As a result, an electromotive force can be generated more effectively between the detection electrode 331 and the reference electrode 320 in accordance with the concentration of the ammonia gas.

Since the selective reaction layer 340 covers the detection electrode 331 such that the detection electrode 331 is not exposed, the gas under measurement passes through the selective reaction layer 340, without fail, before reaching the solid electrolyte member 310. In this case, ammonia gas in the gas under measurement reaches the solid electrolyte member 310 after combustible gasses in the gas under measurement other than ammonia gas have been burned almost completely at the selective reaction layer 340.

Since the detection electrode 331 overlaps the detection lead 332, the detection electrode 331 and the detection lead 332 can be electrically connected in a reliable manner, whereby an electromotive force generated between the reference electrode portion and the detection electrode portion can be reliably transmitted to an external circuit.

Since the detection electrode 331 is formed of a material which contains gold (Au) as a predominant component, the detection portion 331 can exhibit good current-collecting action when exposed to ammonia gas. Further, since the detection lead 332 is formed of a material which contains platinum (Pt) as a predominant component, the electromotive force generated between the detection electrode 331 and the reference electrode portion 320 can be reliably transmitted to an external circuit. Since the detection lead 332, on a weight percentage basis, contains less gold than the detection electrode 331, the catalytic activity of platinum is lowered, and the generation of a potential difference between the detection lead 332 and the reference electrode 320 can be suppressed. In addition, the adhesion strength to the solid electrolyte member 310 and to the detection electrode portion 331 can be increased.

The detection electrode 331 and the detection lead 332 each contains zirconia (ZrO₂), and the detection lead 331, on a weight percentage basis, contains less than zirconia than the detection electrode 332. In this configuration, the detection lead 331 can have enhanced electric conductivity and adhesion to the solid electrolyte member 310.

The selective reaction layer 340 is formed of a metal oxide which contains, as predominant components, vanadium oxide (V₂O₅) and bismuth oxide (Bi₂O₃), which are mixed at a mixing ratio of 45:55 (at %, V: Bi). Therefore, the ammonia gas sensor can secure satisfactory thermal stability over time, as well as good responsiveness and selectivity for ammonia gas.

Since the selective reaction layer 340 is thicker than the detection electrode 331, the selective reaction layer 340 can satisfactorily separate ammonia gas from combustible gasses other than ammonia gas, to thereby prevent combustible gasses other than ammonia gas from reaching the solid electrolyte member 310. In addition, since the thickness of the detection electrode 331 is less than 30 μm, the detection electrode 331 can exhibit satisfactory thermal shock resistance and satisfactory current-collecting characteristics, and can secure satisfactory responsiveness for an ammonia gas component.

Since the protection layer 360 is provided to cover the selective reaction layer 340 such that the selective reaction layer 340 is not exposed, and therefore is not affected by impurities in the gas under measurement, the selective reaction layer 340 can effectively burn combustible gasses in the gas under measurement other than ammonia gas, to thereby prevent combustible gasses from reaching the solid electrolyte member 310.

Next, a method of manufacturing the ammonia gas sensor 1 of Embodiment 1 will be described.

### 1. Step of Forming the Solid Electrolyte Member 310

A powder of partially stabilized zirconia is prepared and charged into a bottomed-tubular rubber mold (not shown). The partially stabilized zirconia is obtained by adding 4.5 mol % of yttrium oxide (Y₂O₃) (stabilizer) to zirconia (ZrO₂). The powder of partially stabilized zirconia is press-molded into a bottomed-tubular shape within the rubber mold, followed by firing at 1490° C. Thus, a solid electrolyte member 310 having a bottomed-tubular shape is fabricated.

### 2. Step of Forming the Reference Electrode 320

Next, platinum (Pt) is applied to the inner surface of the solid electrolyte member 310 by means of electroless plating, and then fired. Thus, the reference electrode 320 is formed on the inner surface of the solid electrolyte member 310.

### 3. Step of Forming the Detection Lead 332 and the Detection Electrode 331

Next, platinum (Pt), zirconia (ZrO₂), an organic solvent and a dispersant are mixed to provide a dispersion mixture. Subsequently, a binder and a viscosity modifier are added to the mixture in respective predetermined amounts, and the mixture is subjected to wet blending. Thus, a paste for the detection lead is prepared. Further, gold (Au), zirconia (ZrO₂), an organic solvent and a dispersant are mixed to provide a second dispersion mixture. Subsequently, a binder and a viscosity modifier are added to the mixture in respective predetermined amounts, and the mixture is subjected to wet blending. Thus, a paste for the detection electrode is prepared.

The paste for the detection electrode and the paste for the detection lead are printed on the bottom surface and side surface of the solid electrolyte member 310 manufactured in the above-described manner. Specifically, the paste for the detection lead is printed in the form of a strip extending in the axial direction of the solid electrolyte member 310, and the paste for the detection electrode is printed such that it overlaps a front end portion of the printed paste for the detection lead. After drying, firing is performed at 1000° C. for one hour. Thus, the detection electrode 331 and the detection lead 332 are formed on the outer surface of the solid electrolyte member 310.

### 4. Step of Forming the Selective Reaction Layer 340

Next, a composite oxide composed of vanadium oxide (V₂O₅) and bismuth oxide (Bi₂O₃), an organic solvent and a dispersant are mixed to provide a dispersion mixture. Notably, vanadium and bismuth, which constitute vanadium oxide and bismuth oxide, respectively, are present at a mixing ratio of 45:55 (at %, V:Bi). Subsequently, a binder and a viscosity modifier are added to the mixture in respective predetermined amounts, and the mixture is subjected to wet blending. Thus, a paste for the selective reaction layer is prepared.

The paste for the selective reaction layer is printed such that it covers the detection electrode 331, and dried, followed by firing at 750° C. for 10 minutes. Thus, the selective reaction layer 340 made of bismuth vanadium oxide (BiVO₄) is formed. Notably, the selective reaction layer 340 may contain vanadium oxide and bismuth oxide, so long as the selective reaction layer 340 is mainly made of bismuth vanadium oxide.

### 5. Step of Forming the Protection Layer 360

Next, alumina (Al₂O₃), an organic solvent and a dispersant are mixed to provide a dispersion mixture. Subsequently, a binder and a viscosity modifier are added to the mixture in respective predetermined amounts, and the mixture is subjected to wet blending. Thus, a paste for the protective layer is prepared.

The paste for the protective layer is printed such that it covers the selective reaction layer 340, and dried, followed by firing at 750° C. for 10 minutes. Thus, the protection layer 360 is formed.

### 6. Step of Assembling the Ammonia Gas Sensor 1

After the sensor element 300 is fabricated in the above-described manner, the sensor element 300 is held within the metallic shell 110. Subsequently, the separator 400 is held within the outer tube 120 via the holding metal piece 610; and the grommet 500, the terminals 700, and the covered wires 710 are assembled into the outer tube 120. Thus, manufacture of the ammonia gas sensor 1 is completed.

### Embodiment 2

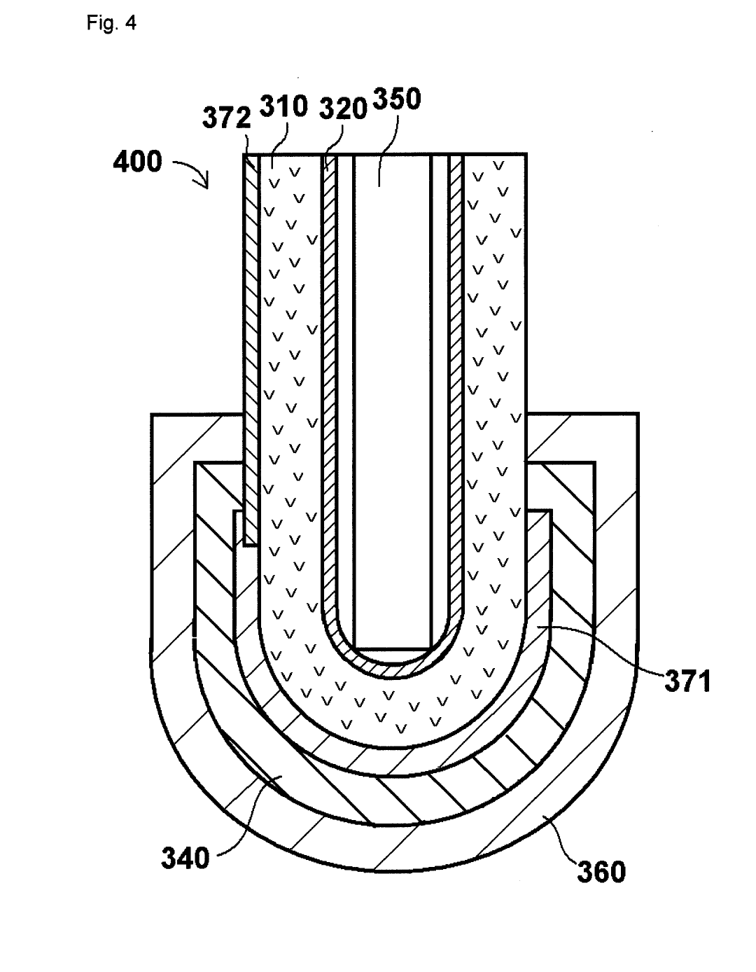

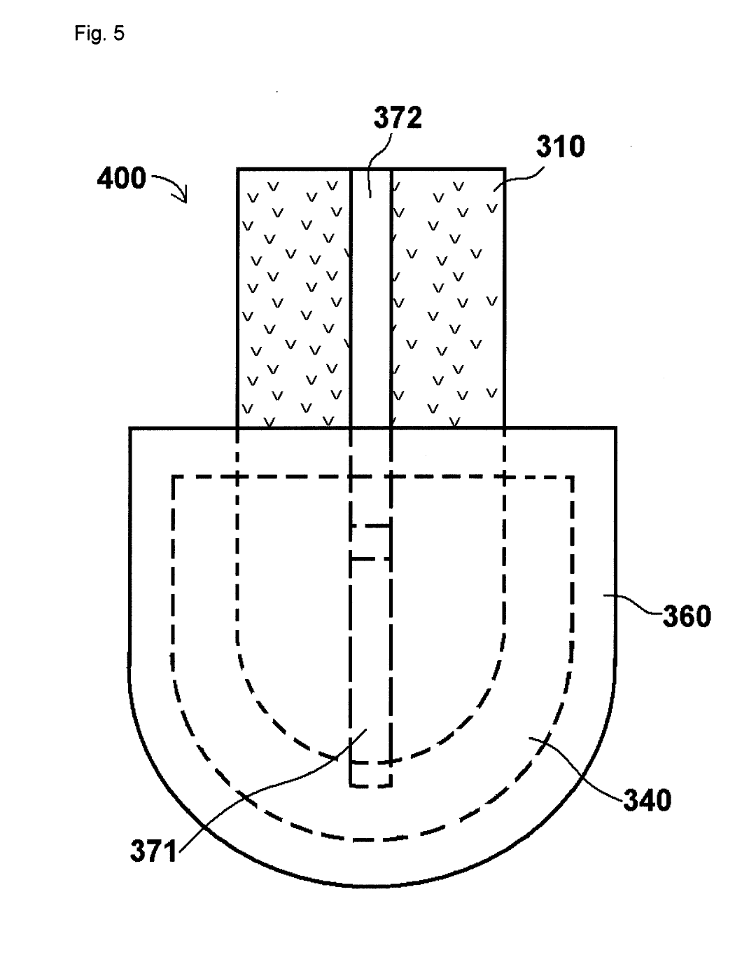

FIG. 4 is an enlarged cross sectional view of a front end portion of a sensor element 400 attached to an ammonia gas sensor 2 of Embodiment 2. FIG. 5 is an enlarged side elevational view of the front end portion of the sensor element 400. The sensor element 400 of Embodiment 2 differs from the sensor element 300 of Embodiment 1 in that instead of the detection electrode 331 and the detection lead 332, a detection electrode 371 and a detection lead 372 are provided. For the ammonia gas sensor 2 of Embodiment 2, the same descriptions applicable to Embodiment 1 will be omitted or simplified, and structural features the same as those of Embodiment 1 are denoted by like reference numerals.

In Embodiment 2, the detection electrode 371 and the detection lead 372 are provided on the surface of the solid electrolyte member 310. The detection electrode portion 371 is formed so as to assume a strip-like shape, and extends symmetrically toward the rear side of the bottom portion of the solid electrolyte member 310 while passing along the bottom portion of the solid electrolyte member 310. The detection lead 372 extends in the axial direction of the solid electrolyte member 310 from the rear end of the detection electrode 371. Notably, the detection electrode 371 is provided such that it overlaps the front end portion of the detection lead 372. The remaining structure is the same as that of Embodiment 1.

Even in the ammonia gas sensor 2 of Embodiment 2, in which the detection electrode 371 assumes a strip-like shape and extends symmetrically toward the rear end side of the solid electrolyte member 310 while passing along the bottom portion of the solid electrolyte member 310, excellent responsiveness and selectivity for ammonia gas can be attained.

### Embodiment 3

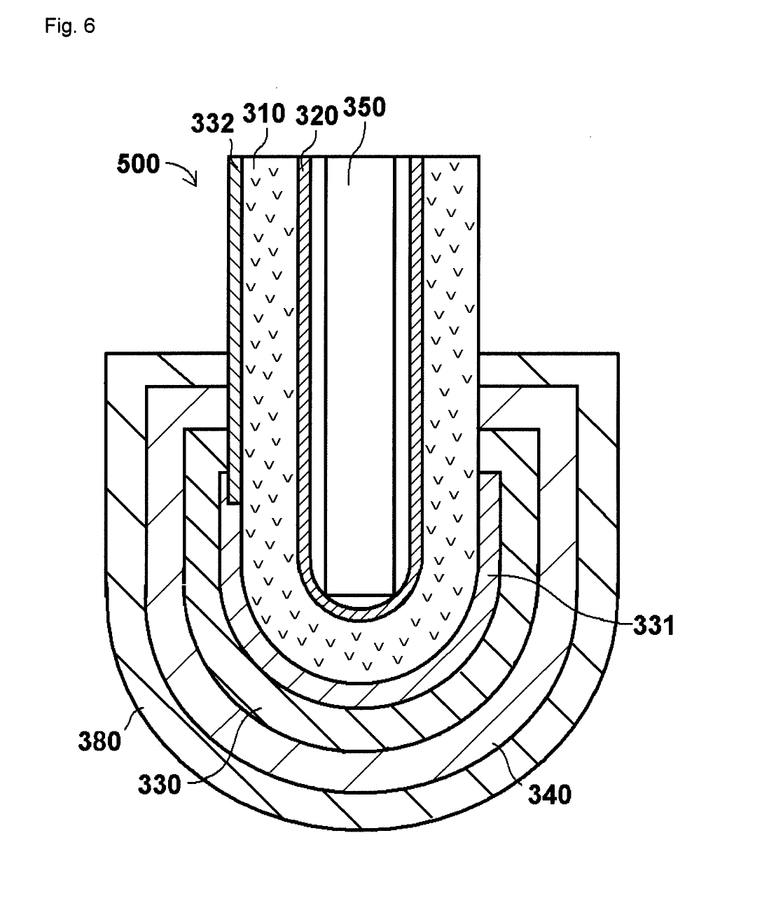

FIG. 6 is an enlarged cross sectional view of a front end portion of a sensor element 500 attached to an ammonia gas sensor 3 of Embodiment 3. The sensor element 500 of Embodiment 3 differs from the sensor element 300 of Embodiment 1 in that a porous layer 330 is provided between the detection electrode 331 and the selective reaction layer 340. For the ammonia gas sensor 3 of Embodiment 3, the same descriptions applicable to Embodiment 1 will be omitted or simplified, and structural features the same as those of Embodiment 1 are denoted by like reference numerals.

In Embodiment 3, the porous layer 330 is provided to cover the detection electrode 331 and a portion of the detection lead 332. The porous layer 330 is formed over the entire outer surface of the detection electrode 331 such that the detection electrode 331 is not exposed to the outside. The porous layer 330 is formed of a porous material which contains alumina (Al₂O₃) as a predominant component.

Further, as shown in FIG. 6, the selective reaction layer 340 is formed over the entire outer surface of the porous layer 330 such that the porous layer 330 is not exposed to the outside. The remaining structure is the same as that of the ammonia gas sensor of Embodiment 1.

As described above, the porous layer 330 is provided between the detection electrode 331 and the selective reaction layer 340 such that the porous layer 330 covers the entire outer surface of the detection electrode 331. Therefore, the detection electrode 331 is securely insulated from the selective reaction layer 340. Accordingly, it is possible to prevent the influence of age-related deterioration of the selective reaction layer 340 on the detection electrode 331.

Next, only those steps of a method of manufacturing the ammonia gas sensor of Embodiment 3 which differ from those of Embodiment 1 will be described.

First, Al₂O₃, an organic solvent, and a dispersant are mixed to provide a dispersion mixture. Subsequently, a binder and a viscosity modifier are added to the mixture in respective predetermined amounts, and the mixture is subjected to wet blending. Thus, a paste for the porous layer is prepared.

The paste for the porous layer is printed on the solid electrolyte member 310 on which the paste for the detection electrode has been printed in Step 3 of Embodiment 1 such that it covers the paste for the detection electrode, and is then dried.

After that, the solid electrolyte member 310 carrying the paste for the detection electrode and the paste for porous layer having been printed and dried is fired at 1000° C. for one hour. Thus, the detection electrode 331 and the porous layer 330 are formed. Notably, the porous layer 330 is formed over the detection electrode 331 such that the detection electrode 331 is not exposed to the outside. Further, the porous layer is fired at a relatively low temperature at which alumina is not fully sintered. As a result, a porous layer is formed.

Subsequently, the paste for the selective reaction layer described in Embodiment 1 is printed on the bottom surface and side surface of the solid electrolyte member 310 so as to cover the porous layer 330, and is then dried, followed by firing at 750° C. for 10 minutes. The selective reaction layer 340 is formed over the porous layer 330 such that the porous layer 330 is not exposed to the outside. The remaining manufacturing steps are the same as those of Embodiment 1.

### Embodiment 4

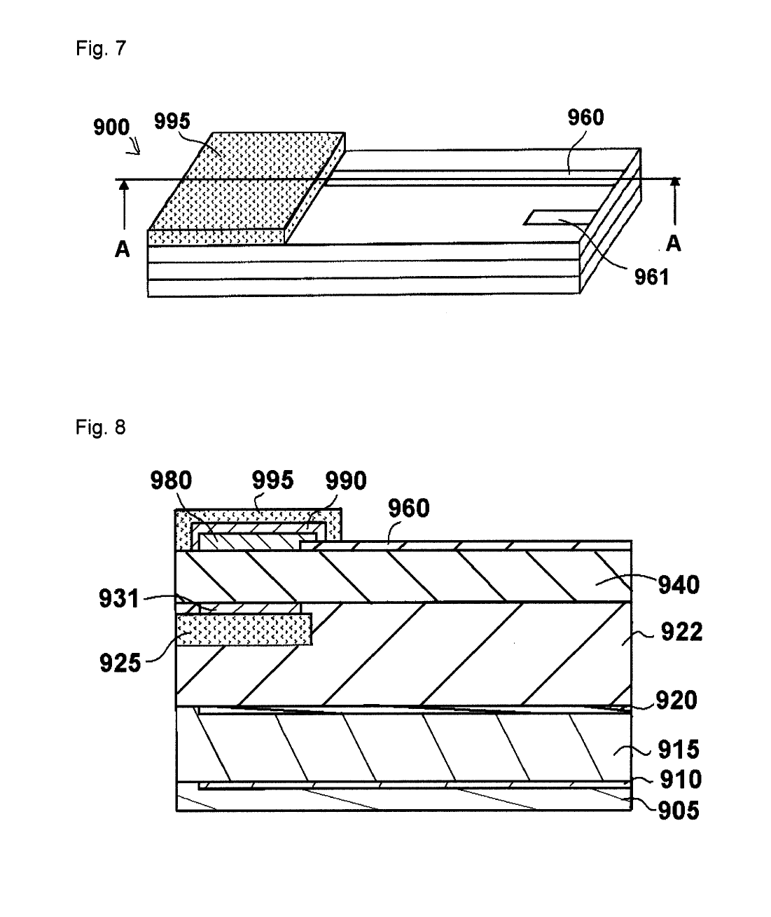

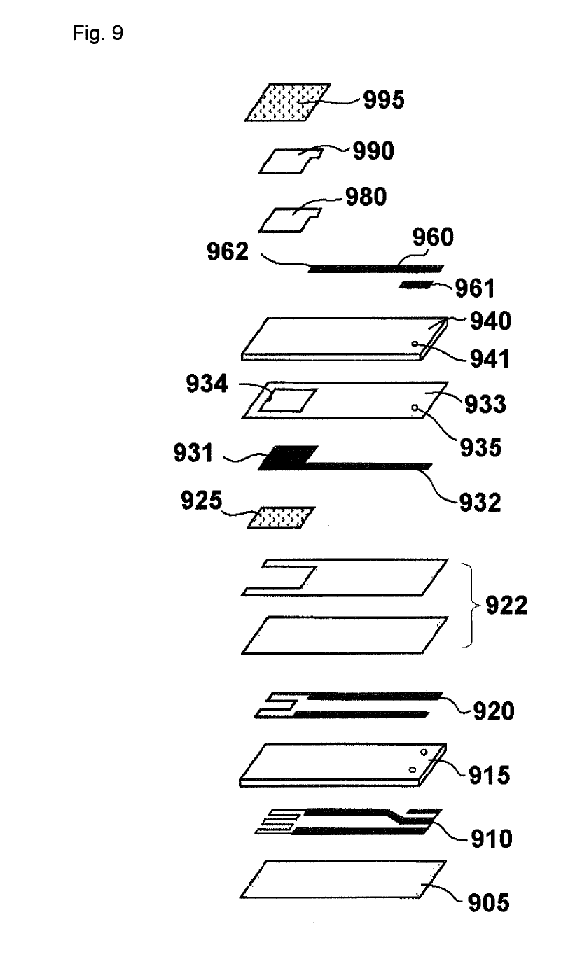

FIG. 7 to 9 show a sensor element 900 of an ammonia gas sensor 4 of Embodiment 4 according to the present invention. The ammonia gas sensor 4 of Embodiment 4 differs from that of Embodiment 1 in that in place of the gas sensor element 300, a plate-type sensor element 900 is incorporated into the ammonia gas sensor 4. The remaining portions have the same structure as those of Embodiment 1. Notably, for the ammonia gas sensor 4 of Embodiment 4, the same descriptions applicable to Embodiment 1 will be omitted or simplified, and structures the same as those of Embodiment 1 are denoted by like reference numerals.

The plate-type sensor element 900 is coaxially held within the metallic shell 110. The sensor element 900 includes a solid electrolyte member 940 formed of the same material as the solid electrolyte member 310 of Embodiment 1.

A reference electrode 931 and a reference lead 932 are provided on the back surface of the solid electrolyte member 940 via an insulating film 933. The reference electrode 931 is disposed at a position corresponding to an opening 934 formed in a front end of the insulating film 933, and is in close contact with a front end of the solid electrolyte member 940. Meanwhile, the reference lead 932 is formed to extend from a front end toward a rear end of the back surface of the insulating film 933. The reference lead 932 is electrically connected to an electrode pad 961 via a through-hole 935 of the insulating film 933 and a through-hole 941 of the solid electrolyte member 940. Notably, the reference electrode 931 is formed of a material which contains Pt (predominant component) and partially stabilized zirconia (12 wt %) containing 5.4 mol % yttria. Meanwhile, the reference lead 932 is formed of a material which contains Pt (predominant component) and alumina (5 wt %).

Further, a protection layer 925 is formed on the back surface of the reference electrode 931. Moreover, an insulating layer 922 is formed on the back surface of the insulating film 933 such that the reference lead 932 and the protection layer 925 are sandwiched between the insulating film 933 and the insulating layer 922. Further, a heater 920, an insulating layer 915, a temperature sensor 910, and an insulating layer 905 are stacked in this order on the back surface of the insulating layer 922.

Meanwhile, a detection lead 960 and an electrode pad 961, which are formed of a material which contains platinum (Pt) (predominant component) and partially stabilized zirconia (5 wt %) containing 4 mol % yttria, are formed on the front surface of the solid electrolyte member 940. The detection lead 960 and the electrode pad 961 extend along the surface of the solid electrolyte member 940 from the front end side toward the rear end side thereof.

A detection electrode 980 is formed such that it overlaps a front end 962 of the detection lead 960. The detection electrode 980 is formed of a material which contains gold (Au) (predominant component) and partially stabilized zirconia (10 wt %) containing 4 mol % yttria such that it is in close contact with the surface of the solid electrolyte member 940. Furthermore, the selective reaction layer 990, which is formed of the same material as the selective reaction layer 340 described in Embodiment 1, is provided on the surface of the detection electrode portion 980. Moreover, a protection layer 995 which contains Al₂O₃ as a predominant component is formed on the surface of the selective reaction layer 990 such that the selective reaction layer 990 is not exposed.

In the ammonia gas sensor 4 configured as described, the selective reaction layer 990 effectively burns and removes combustible gases in a gas under measurement, and prevents the combustible gases from reaching the solid electrolyte member 940. The detection electrode 980 exhibits a current-collecting action upon exposure to ammonia gas, to generate an electromotive force between the reference electrode 932 and the detection electrode 980 in accordance with the concentration of ammonia gas. Therefore, the ammonia gas sensor 4 has excellent responsiveness and selectivity for ammonia gas.

The detection electrode 980, on a wt % basis, contains less zirconia (ZrO₂) the zirconia content than the reference electrode 931. This configuration allows the detection electrode 980 to have a satisfactory responsiveness for ammonia gas, while maintaining adhesion to the solid electrolyte member 940. Further, the zirconia (ZrO₂) content of the detection lead 960 is less than the zirconia content of the detection electrode 980 (on a wt % basis). This configuration allows the detection lead 960 to have enhanced electrical conductivity, while maintaining adhesion to the solid electrolyte member 940.

### TEST EXAMPLE 1

In Test Example 1, the sensitivity of the ammonia gas sensor 1 of Embodiment 1 was evaluated. In this evaluation, the ammonia gas sensor 1 of Embodiment 1 is referred to as “Example 1.” Further, an ammonia gas sensor serving as a comparative example (hereinafter referred to as “Comparative Example 1”) was prepared for comparison.

Specifically, Comparative Example 1 was fabricated without detection electrode 331, and the selective reaction layer was formed on the solid electrolyte member 310 from bismuth vanadium oxide (BiVO₄).

A model gas generation apparatus was used for the evaluation. The model gas generation apparatus generates a gas for evaluation as described below.

First, a base gas containing 10% oxygen (O₂), 5% carbon dioxide (CO₂), 5% water (H₂O) and balance nitrogen (N₂) on a volume basis was prepared. Subsequently, ammonia gas (NH₃), propylene gas (C₃H₆), carbon monoxide gas (CO) and nitrogen monoxide gas (NO) were selectively added to the base gas each in an amount of 100 ppm to obtain the gas for evaluation. The temperature of the gas for evaluation was set to 280° C.

Example 1 and Comparative Example 1 were placed in the model gas generation apparatus, and the gas for evaluation was generated therein. Then, for Example 1, the potential difference produced between the reference electrode 320 and the detection electrode 331 was measured. On the other hand, for Comparative Example 1, the potential difference produced between the reference electrode 320 and the bismuth vanadium oxide (BiVO₄) layer was measured. Notably, the temperature of each of Example 1 and Comparative Example 1 was controlled and maintained at 650° C. by action of the heater 350.

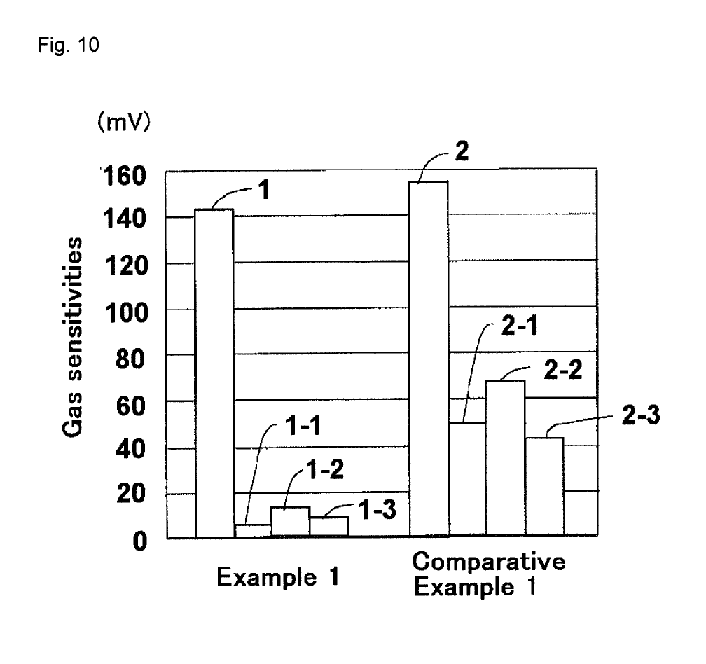

The gas sensitivities (mV) of Example 1 and Comparative Example 1 were measured for each gas component of the gas for evaluation. The gas sensitivity was obtained by subtracting an electromotive force generated when exposed to the base gas from an electromotive force generated when exposed to the gas for evaluation. FIG. 10 shows the results. In FIG. 10, bars 1 to 1-3 respectively show the gas sensitivities of Example 1 for the gas components; i.e., ammonia gas (NH₃), propylene gas (C₃H₆), carbon monoxide gas (CO) and nitrogen monoxide gas (NO). Further, bars 2 to 2-3 respectively show the gas sensitivities of Comparative Example 1 for the gas components; i.e., ammonia gas, propylene gas, carbon monoxide gas and nitrogen monoxide gas.

Both Example 1 and Comparative Example 1 exhibited high sensitivity for ammonia gas. However, the sensitivities of Comparative Example 1 for each of propylene gas, carbon monoxide gas and nitrogen monoxide gas was higher than that of Example 1. That is, Example 1 had a higher selectivity for ammonia gas than Comparative Example 1.

### TEST EXAMPLE 2

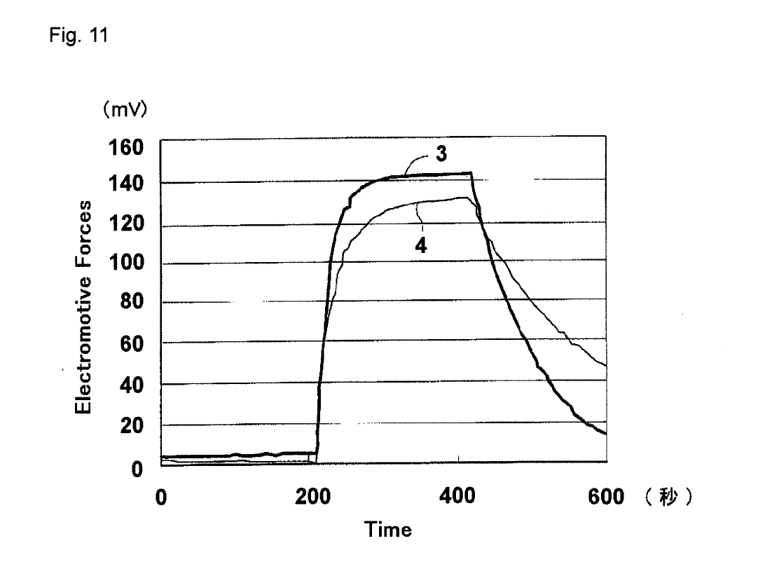

Next, Example 1 and Comparative Example 1 were evaluated for responsiveness. Specifically, Example 1 and Comparative Example 1 were placed in the same model gas generation apparatus used in Test Example 1. The base gas of Test Example 1 was supplied until 200 seconds had elapsed after start of the test, and the gas for evaluation containing ammonia gas (100 ppm) was then supplied until 400 seconds had elapsed after start of the test. FIG. 11 shows the results. Notably, FIG. 11 shows the change in electromotive force of Example 1 and Comparative Example 1 with time; i.e., the responsiveness of each of Example 1 and Comparative Example 1. In FIG. 11, curve 3 shows the responsiveness of Example 1, and curve 4 shows the responsiveness of Comparative Example 1.

As shown in FIG. 11, Example 1 had a higher responsiveness than Comparative Example 1 at both the time of start of supply of the gas for evaluation and at the time of completion of the supply.

### TEST EXAMPLE 3

Next, a change in gas sensitivity with the mixing ratio of vanadium was evaluated. Examples 2 to 5 were fabricated in the same manner as Example 1, except that the mixing ratio of vanadium and bismuth in the selective reaction layer, forming vanadium oxide and bismuth oxide, respectively, differed from that of Example 1. Specifically, the vanadium contents of Examples 2 to Examples 8 were 5 at %, 20 at %, 25 at %, 35 at %, 50 at %, 55 at %, and 95 at %, respectively, given as (V/V+Bi) in terms of at %.

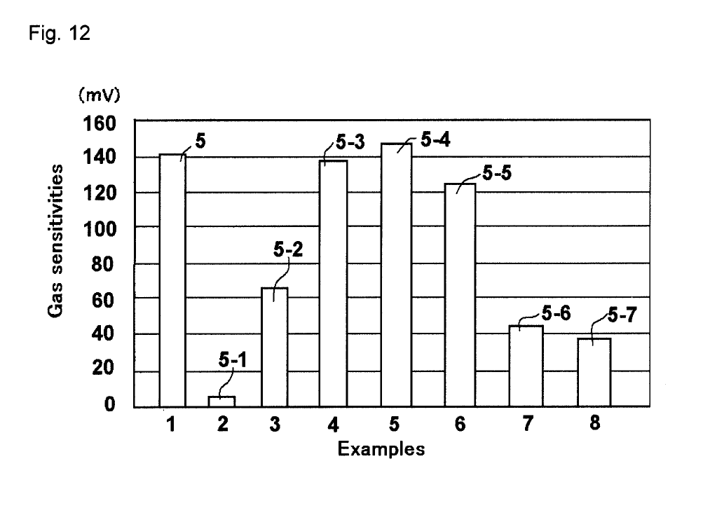

The evaluation was performed as follows. The ammonia gas sensors 1 of Examples 2 to 8 were placed in the same model gas generation apparatus used in Example 1. A gas for evaluation obtained by adding ammonia gas (NH₃) (100 ppm) to the base gas of Example 1 was supplied. FIG. 12 shows the results. Notably, FIG. 12 shows the results for Example 1 as well.

The results show that each of Example 1 and Examples 4 to 6, whose vanadium mixing ratios, namely, V/(V+Bi) in terms of at %, fall within the range of 25 at % to 50 at % exhibited high sensitivity for ammonia gas. When the vanadium mixing ratio (vanadium content) of the selective reaction layer was set within the range of 25 at % to 50 at %, sensitivity for ammonia gas could be secured more satisfactorily.

### TEST EXAMPLE 4

Next, the dependence of gas sensitivity on a component added to the selective reaction layer 340 was evaluated. Examples 9 to 11 were manufactured in the same manner as Example 1, except that the metal oxide forming the selective reaction layer 340 contained tungsten (5 at %) in Example 9, niobium (5 at %) in Example 10, and magnesium (2.5 at %) in Example 11, as an atom fraction of metals constituting the metal oxide.

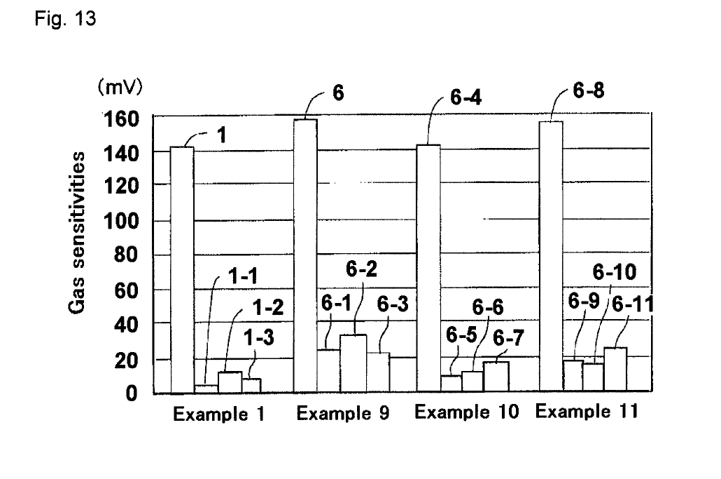

The evaluation was performed as follows. The ammonia gas sensors 1 of Examples 9 to 11 were placed in the same model gas generation apparatus as in Example 1. Gasses for evaluation obtained by adding, to the base gas of Example 1, 100 ppm of ammonia gas (NH₃), propylene gas (C₃H₆), carbon monoxide gas (CO) and nitrogen monoxide gas (NO), respectively, were selectively supplied. FIG. 13 shows the results, Notably, FIG. 13 shows the results for Example 1 as well.

In FIG. 13, bars 6 to 6-3 respectively show the gas sensitivity of Example 9 for each of ammonia gas, propylene gas carbon monoxide gas, and nitrogen monoxide gas. Bars 6-4 to 6-7 respectively show the gas sensitivity of Example 10 for each of ammonia gas, propylene gas, carbon monoxide gas and nitrogen monoxide gas. Bars 6-8 to 6-11 respectively show the gas sensitivity of Example 11 for each of ammonia gas, propylene gas, carbon monoxide gas and nitrogen monoxide gas.

The gas sensitivities of the ammonia gas sensors 1 of Examples 1 and 9 to 11 were found to be high for ammonia gas, and low for propylene gas, carbon monoxide gas, and nitrogen monoxide gas as in the case of Example 1. Therefore, even when the selective reaction layer 340 contains an additive as well as a metal oxide as in Examples 9 to 11, satisfactory gas selectivity can be attained as in the case of Example 1.

### TEST EXAMPLE 5

Next, the dependence of gas sensitivity on the thickness of the detection electrode portion 331 was evaluated. Examples 12 and 13 were manufactured in the same manner as in Example 1, except that the thickness of the detection electrode portion 331 was set to 30 μm in the case of Example 12, and 60 μm in the case of Example 13.

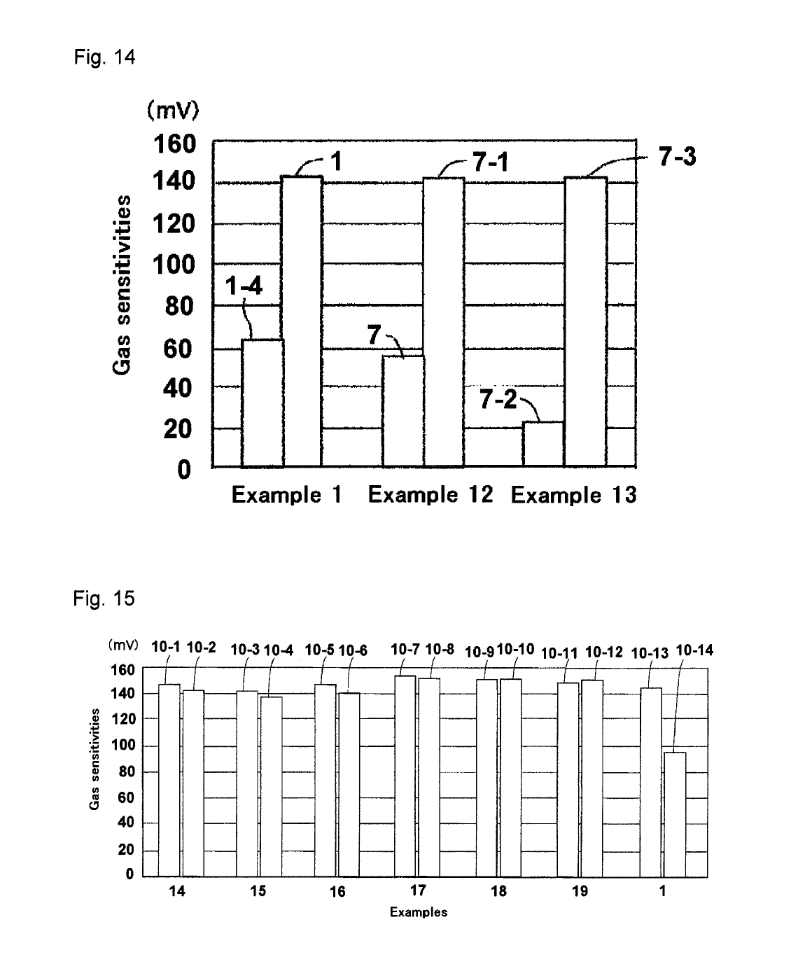

The evaluation was performed as follows. Examples 12 and 13 were placed in the model gas generation apparatus of Example 1. A gas for evaluation obtained by adding 10 ppm or 100 ppm ammonia gas (NH₃) to the base gas of Example 1 was supplied. FIG. 14 shows the results. Notably, FIG. 14 shows the results for Example 1 (thickness: 20 μm) as well. The selective reaction layers 340 of Examples 12 and 13 each had a thickness of 30 μm as in Example 1.

In FIG. 14, bars 1-4, 7, and 7-2 respectively show the gas sensitivities of Examples 1, 12 and 13 for 10 ppm ammonia gas. Bars 1, 7-1, and 7-3 respectively show the gas sensitivities of Examples 1, 12 and 13 for 100 ppm ammonia gas.

As seen from FIG. 14, when the concentration of ammonia gas is 100 ppm, each of Examples 1, 12 and 13 exhibited a high gas sensitivity for ammonia gas. In contrast, when the concentration of ammonia gas is 10 ppm, the greater the thickness of the detection electrode layer 331, the lower the gas sensitivity for ammonia gas. Preferably, the thickness of the selective reaction layer is less than 30 μm in order to enable the ammonia gas sensor to have a satisfactory sensitivity for ammonia gas.

### TEST EXAMPLE 6

Next, the characteristics of the ammonia gas sensor 3 of Example 3 were evaluated on the basis of gas sensitivity before an actual use test and after the actual use test. For this evaluation, the ammonia gas sensor 3 of Embodiment 3 is referred to as “Example 14.” In addition to Example 14, Examples 15 to 19 and Example 1 were prepared. The material of the porous layer was MgAl₂O₄ in Example 15, SiO₂ in Example 16, SiO₂/Al₂O₃ in Example 17, zeolite (ZSM-5) in Example 18, and SiC in Example 19. Notably, Examples 15 to 19 had the same configuration as Example 14, except for the material of the porous layer.

The evaluation was performed as follows. Examples 14 to 19 were placed in the model gas generation apparatus of Example 1. A gas for evaluation obtained by adding 100 ppm ammonia gas (NH₃) to the base gas of Example 1 was supplied.

For the actual use test, a 3.0 liter diesel engine was used as an engine test bench, and Example 1 and Examples 15 to 19 were disposed on the downstream side of an oxidation catalyst device (DOC) and DPF (Diesel Particulate Filter) provided on an exhaust pipe of the diesel engine.

In the actual use test, a cycle test in which the engine was alternately operated at an idling speed for 10 minutes and at 3000 rpm for 30 minutes was performed for 500 hours. FIG. 15 shows the results.

In FIG. 15, bars 10-1, 10-3, 10-5, 10-7, 10-9, 10-11 and 10-13 respectively show the gas sensitivities of Examples 14 to 19 and 1 placed in the model gas generation apparatus before the actual use test. Further, in FIG. 15, bars 10-2, 10-4, 10-6, 10-8, 10-10, 10-12, and 10-14 respectively show the gas sensitivities of Examples 14 to 19 and 1 placed in the model gas generation apparatus after the actual use test.

As shown in FIG. 15, the gas sensitivity of Example 1 as measured after the actual use test decreased as compared with that before the actual use test. In contrast, the gas sensitivities of Examples 14 to 19 hardly changed. That is, the porous layer 330 allows for an ammonia gas sensor having a high selectivity for ammonia gas, excellent responsiveness and highly stable characteristics over a long period of time following the actual use test.

The present invention is not limited to the above-described embodiments, and may be modified in practice. For example:

(1) In Embodiments 1 to 4 of the present invention, the detection electrode 331, 371, 980 is provided on the solid electrolyte member 310, 940, and the selective reaction layer 340, 990 is provided thereon. However, Embodiments 1 to 4 may be modified such that the selective reaction layer 340, 990 is provided on the solid electrolyte member 310, 940, and the detection electrode portion 331, 371, 980 is provided thereon.

(2) The electrode material which forms the detection electrodes 331, 371 and 980 of Embodiments 1 to 4 of the present invention may contain platinum (Pt), as a predominant component, instead of gold.

(3) The selective reaction material of Embodiments 1 to 4 of the present invention may be formed from antimony oxide (Sb₂O₃) instead of bismuth oxide. Further, in order to finely adjust the catalytic action of the selective reaction layer 340 or improve the thermal stability thereof, at least one of WO₃, MoO₃, Nb₂O₅, Ta₂O₅, MgO, CaO, SrO and BaO may be added to the selective reaction material in an amount of up to about 5 mol %.

(4) In Embodiment 4 of the present invention, the reference electrode 931 and the detection electrode 980 face each other via the solid electrolyte member 940. However, the reference electrode 931 and the detection electrode 980 may be disposed side by side on the same side of the solid electrolyte member 940.

(5) In Embodiments 1 to 4 of the present invention, the protection layer 360, 995 is formed by printing a paste for the protection layer. However, the protection layer 360, 995 may be formed by means of thermal spraying.

(6) Application of the ammonia gas sensor of the present invention is not limited to the exhaust gas system of an internal combustion engine, and the present invention can be applied to any other engine, apparatus, or the like which generates an exhaust gas.

While the invention has been described in detail and with reference to specific embodiments thereof, it will be apparent to one skilled in the art that various changes and modifications can be made therein without departing from the spirit and scope thereof.

This application is based on Japanese Patent Application No. 2007-181607 filed Jul. 11, 2007, No. 2007-269722 filed Oct. 17, 2007 and No. 2008-120859 filed May 7, 2008, the above-noted applications incorporated herein by reference in their entirety.

What is claimed is:

1. An ammonia gas sensor comprising:
a solid electrolyte member extending in an axial direction and containing zirconia as a predominant component;
a reference electrode provided on the solid electrolyte member; and
a detection electrode and a selective reaction layer provided on the solid electrolyte member, wherein the detection electrode serves as a counterpart of the reference electrode,
wherein the detection electrode contains a noble metal as a predominant component, and the selective reaction layer contains a metal oxide as a predominant component.

2. The ammonia gas sensor according to claim 1, wherein the detection electrode is arranged between the solid electrolyte member and the selective reaction layer.

3. The ammonia gas sensor according to claim 2, wherein the detection electrode is disposed directly on the solid electrolyte member.

4. The ammonia gas sensor according to claim 1, wherein the selective reaction layer covers the detection electrode such that the detection electrode is not exposed.

5. The ammonia gas sensor according to claim 4, further comprising a strip-shaped detection lead which extends in the axial direction from the detection electrode so as to electrically connect the detection electrode to an external circuit, wherein the detection electrode overlaps the detection lead.

6. The ammonia gas sensor according to claim 1, wherein
the solid electrolyte member assumes the form of a bottomed tube having a bottom portion at a front end side thereof;
the reference electrode is formed on an inner surface of the solid electrolyte member; and
the detection electrode is provided on an outer surface of a front end portion of the solid electrolyte member.

7. The ammonia gas sensor according to claim 6, wherein the detection electrode assumes a strip-like shape and extends symmetrically toward the rear end side of the solid electrolyte member while passing along the bottom of the solid electrolyte member.

8. The ammonia gas sensor according to claim 4, wherein the detection electrode is formed of a material which contains platinum as a predominant component and gold, or a material which contains gold as a predominant component.

9. The ammonia gas sensor according to claim 4, wherein the detection lead is formed of a material which contains platinum as a predominant component.

10. The ammonia gas sensor according to claim 9, wherein, on a weight percentage basis, the gold content of the detection lead is less than the gold content of the detection electrode.

11. The ammonia gas sensor according to claim 4, wherein the reference electrode and the detection electrode each contains zirconia, and, on a weight percentage basis, the zirconia content of the detection electrode is less than the zirconia content of the reference electrode.

12. The ammonia gas sensor according to claim 4, wherein the detection lead contains zirconia, and, on a weight percentage basis, the zirconia content of the detection lead is less than the zirconia content of the detection electrode.

13. The ammonia gas sensor according to claim 2, further comprising a porous layer arranged between the detection electrode and the selective reaction layer.

14. The ammonia gas sensor according to claim 13, wherein the porous layer covers the detection electrode such that the detection electrode is not exposed.

15. The ammonia gas sensor according to claim 13, wherein the selective reaction layer covers the porous layer such that the porous layer is not exposed.

16. The ammonia gas sensor according to claim 3, wherein the porous layer contains at least one selected from the group consisting of Al₂O₃, MgAl₂O₄, SiO₂, SiO₂/Al₂O₃, porous aluminosilicate and SiC.

17. The ammonia gas sensor according to claim 2, further comprising a protection layer covering the selective reaction layer such that the selective reaction layer is not exposed.

18. The ammonia gas sensor according to claim 1, wherein the selective reaction layer contains, as a predominant component, at least one of bismuth vanadium oxide and antimony vanadium oxide.

19. The ammonia gas sensor according to claim 18, wherein the selective reaction layer further contains, as an additional component, at least one oxide selected from the group consisting of tungsten oxide, molybdenum oxide, niobium oxide, tantalum oxide, magnesium oxide, calcium oxide, strontium oxide and barium oxide.

20. The ammonia gas sensor according to claim 18, wherein the selective reaction layer contains vanadium in an amount of 25 at % to 50 at % based on total content of vanadium, antimony and bismuth in the selective reaction layer.

21. The ammonia gas sensor according to claim 1, wherein the selective reaction layer is thicker than the detection electrode.

22. The ammonia gas sensor according to claim 1, wherein the detection electrode has a thickness of less than 30 μm.
